(19) United States
(12) Patent Application Publication
(10) Pub. No.: US 2020/0363029 A1
(43) Pub. Date: Nov. 19, 2020

(54) IMITATION FLAME AND IMITATION FLAME LAMP HAVING THE SAME

(71) Applicant: SHENZHEN HAOJING INDUSTRY CO., LTD., Shenzhen (CN)

(72) Inventors: Guangquan Huang, Shenzhen (CN); Shengwei Liu, Shenzhen (CN)

(21) Appl. No.: 16/984,275

(22) Filed: Aug. 4, 2020

(30) Foreign Application Priority Data
Sep. 4, 2019 (CN) 201921466654.8

(51) Int. Cl. F21S 10/04

(52) U.S. Cl. CPC F21S 10/046; F21Y 2115/10

(57) ABSTRACT

An imitation flame includes a flame shell, a first illuminant and a flame component. The flame shell is provided with a cavity in which the first illuminant is configured, and the flame component is formed at a top of the cavity. The imitation flame can achieve an excellent imitation effect and lower cost.

### FIELD OF THE INVENTION

The present invention relates to an imitation flame device, and more particularly to an imitation flame and an imitation flame lamp having the same.

### BACKGROUND OF THE INVENTION

The existing imitation flame lamp usually only provides an imitation flame with a single color, for example yellow flame. However, in a real burning flame, the color of the flame core is blue; the color of the flame far away from the flame core is yellow; while the outer flame (namely the flame top) is red. That is, two or more colors are presented in the real burning flame. Therefore, the imitation effect of the existing imitation flame lamp with a single color flame is undesired.

### SUMMARY OF THE INVENTION

One objective of the present invention is to provide an imitation flame which achieves an excellent imitation effect and lower cost.

Another objective of the present invention is to provide an imitation flame lamp which achieves an excellent imitation effect and lower cost.

To achieve the mentioned above objectives, the present invention provides an imitation flame including a flame shell, a first illuminant and a flame component. The flame shell is provided with a cavity in which the first illuminant is configured, and the flame component is formed at a top of the cavity.

In comparison with the prior art, since the first illuminant and the flame component are formed in the flame shell, when the first illuminant is lighted, the upward light emitted from the first illuminant is diverged to the top wall of the flame shell to enhance the intensity and color of the light around the inner top of the flame shell. In such a way, the imitation effect is improved; furthermore, the structure is simple to reduce manufacturing cost.

Preferably, the flame component is made of sponge.

Preferably, a separation plate is provided inside the flame shell to divide the cavity into a first cavity and a second cavity which are located from up to down, and the first illuminant is configured at one side of the separation plate and located in the first cavity.

Preferably, a second illuminant is configured at another side of the separation plate and located in the second cavity.

Accordingly, an imitation flame lamp includes a main body and the imitation flame mentioned above, and the imitation flame is swingable and formed on the main body

### BRIEF DESCRIPTION OF THE DRAWINGS

The accompanying drawings facilitate an understanding of the various embodiments of this invention. In such drawings:

FIG. 1 is a perspective view of an imitation flame lamp according to an embodiment of the present invention; and

FIG. 2 is sectional view of the imitation flame lamp according to an embodiment of the present invention.

### DETAILED DESCRIPTION OF ILLUSTRATED EMBODIMENTS

The present invention will be described in detail below with reference to the accompanying drawings and preferred embodiments.

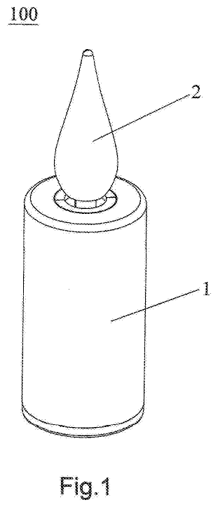

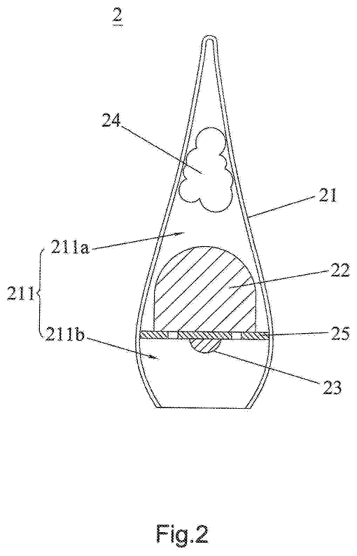

As illustrated in FIGS. 1 and 2, an imitation flame lamp 100 of the present invention includes a main body 1 and an imitation flame 2 that is swingable and formed on the main body 1. The imitation flame 2 includes a flame shell 21, a first illuminant 22, a second illuminant 23 and a flame component 24. A cavity 211 is formed inside the flame shell 21, and the first illuminant 22 and the second illuminant 23 are configured in the cavity 211, and the flame component 24 is formed at a top of the cavity 211. Specifically, the flame component 24 is made of sponge which is red, for example, so as to simulate the color of the real flame. The sponge can be directly inserted within the top of the flame shell 21, thus the assembly is simple, and the manufacturing method is low. Further, a power source (not shown) is provided in the main body 1, so as to electrically connect with the first illuminant 23 and the second illuminant 23.

As shown in FIG. 2, a separation plate 25 is provided inside the flame shell 21 to divide the cavity 211 into a first cavity 211a and a second cavity 211b which are located from up to down, and the first illuminant 22 is configured at one side of the separation plate 25 and located in the first cavity 2111a. As an embodiment, the first illuminant 22 is an LED lamp emitting yellow light, which causes the wall surface of the first cavity 211a to form a yellow layer when emitting light, and the second illuminant 23 is an LED lamp emitting blue light, which causes the wall surface of the second cavity 211b to form a blue layer when emitting light. In such a way, the color level effect of the flame shell 21 can be further improved, to improve the simulation effect.

In comparison with the prior art, since the separation plate 25 is formed in the flame shell 21, to divide the cavity 211 into the first cavity 211a and the second cavity 211b, and the first illuminant 22 inside the first cavity 211a is configured to emit yellow light, the second illuminant 23 inside the second cavity 211b is configured to emit blue light, by means of the sponge, the upward light emitted from the first illuminant 23 is diverged to the top wall of the flame shell 21 to enhance the intensity and color of the light around the inner top of the flame shell 21. When the first and the second illuminants 22 and 23 are lighted, the flame shell 21 shows a flame effect including a red layer, a yellow layer and a blue layer, from up to down, which is similar to the real flame. By this token, the imitation effect is improved; furthermore, the structure is simple to reduce manufacturing cost.

It should be noted that, the flame shell 21 of the imitation flame lamp 100 according to the present invention may swing naturally, or swing under an action of a drive device, thereby achieving a realistic flaming effect. While the structure and the principle of the drive device are well known to the person skilled in the art, which is omitted here.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An imitation flame, comprising a flame shell, a first illuminant and a flame component, wherein the flame shell is provided with a cavity in which the first illuminant is configured, and the flame component is formed at a top of the cavity.

2. The imitation flame according to claim 1, wherein the flame component is made of sponge.

3. The imitation flame according to claim 1, wherein a separation plate is provided inside the flame shell to divide the cavity into a first cavity and a second cavity which are located from up to down, and the first illuminant is configured at one side of the separation plate and located in the first cavity.

4. The imitation flame according to claim 3, further comprising a second illuminant configured at another side of the separation plate and located in the second cavity.

5. An imitation flame lamp, comprising a main body and the imitation flame according to claim 1, and the imitation flame being swingable and formed on the main body.
